(19) United States
(12) Patent Application Publication
(10) Pub. No.: US 2004/0087704 A1
(43) Pub. Date: May 6, 2004

(54) Elastomeric composition

(76) Inventors: Glenn E. Jones, Kingwood, TX (US); Donald S. Tracey, Kingwood, TX (US); Walter H. Waddell, Pasadena, TX (US)

Correspondence Address: ExxonMobil Chemical Company, Law Technology, PO Box 2149, Baytown, TX, 77522-2149, US

(21) Appl. No.: 10/398,301

(22) PCT Filed: Oct. 16, 2001
(86) PCT No.: PCT/US01/42772

(30) Foreign Application Priority Data
Oct. 18, 2000 (US) 09691764
Sep. 7, 2001 (US) 60318048

(51) Int. Cl. C08K 3/26; C08K 3/34; C08K 5/01

(52) U.S. Cl. 524/474; 524/425; 524/445; 524/13; 524/492

(57) ABSTRACT

An embodiment of the present invention is a composition suitable for an air barrier. The composition may include a butyl rubber, a filler, and polybutene processing oil having a number average molecular weight of at least 400 in one embodiment, and a number average molecular weight of less than 10,000 in another embodiment. The filler can be such materials as calcium carbonate, clay, mica, silica and silicates, talc, titanium dioxide, starch, wood flower, carbon black, and mixtures thereof. The viscosity of the polybutene processing oil is greater than 10 cSt at 100° C in one embodiment, and naphthenic oil is substantially absent. The air permeability of the cured compositions of the invention ranges from 1×10⁻⁸ to 4.5×10⁻⁸ cm³·cm/cm²·sec·atm at 65° C. in one embodiment, and has improved aging properties suitable for use as an innerliner or innertube.

### FIELD OF INVENTION

The present invention relates to compositions of butyl rubber and/or branched butyl rubber (“butyl rubber”) with polybutene processing oil, and more particularly to a butyl rubber component blended with polybutene processing oil to form an air barrier such as a tire innerliner or innertube.

### BACKGROUND OF THE INVENTION

Butyl-type rubbers (hereinafter “butyl rubber”) are the elastomers of choice for best air-retention in certain tire innerliners and innertubes for passenger, truck/bus, and aircraft applications. Improvement in air retention in pneumatic tires in order to increase the durability and value of the tires is desirable for certain applications. In particular, locations where road surfaces are in poor condition result in air leakage around the rim seal of tires, thus decreasing the utility of a tubeless tire utilizing an innerliner. Further, harsh driving conditions such as poor road surfaces, overloaded vehicles and long hours of driving can cause heat buildup in the innerliner or innertube, thus causing premature deterioration. Thus, air barriers having improved heat resistance and air retention, while maintaining processability, are of great interest.

Butyl and branched (“star-branched”) butyl rubbers are isobutylene-based elastomers that can be formulated for these specific applications. The selection of ingredients for the final commercial formulation depends upon the balance of properties desired. Namely, processing properties of the green (precured) composition in the tire plant versus in-service performance of the cured tire composite or innertube are important, as is the nature of the tire, such as bias or radial, and its intended end use (e.g, aircraft, motorcycle, bicycle, commercial or automobile). A continuing problem in the tire and innerliner industry is the ability to improve the processability of the innerliners or innertubes without compromising a desirably low air permeability.

Resins and oils (or “processing aids”) naphthenic, paraffinic, and aliphatic resins may be used to improve the processability of elastomeric compounds. However, increased processability in the presence of oils and resins comes at the price of a loss of air impermeability, among other undesirable effects of various other properties.

Polybutene and paraffinic-type processing oils have been disclosed in U.S. Pat. No. 4,279,284 to Spadone, U.S. Pat. No. 5,964,969 to Sandstrom et al. and EP 0 314 416 to Mohammed. A paraffinic-type processing oil is disclosed in U.S. Pat. No. 5,631,316 to Costemalle et al. Also, WO 94/01295 to Gursky et al. discloses the use of petroleum waxes and naphthenic oils and resins in a rubber composition for tire sidewalls, and U.S. Ser. No. 09/691,764, filed Oct. 18, 2000 (assigned to the assignee of the present invention) to Waddell et al. discloses a colorable rubber compositions. Other disclosures of processing oil or resin-containing elastomeric or adhesive compositions include U.S. Pat. Nos. 5,005,625, 5,013,793, 5,162,409, 5,178,702, 5,234,987, 5,234,987, 5,242,727, 5,397,832, 5,733,621, 5,755,899, EP 0 682 071 A1, EP 0376 558B1, WO 92/16587, and JP11005874, JP05179068A and J03028244. None of these disclosures solves the problem of improving processability of elastomeric compositions useful for tires, air barriers, etc, while maintaining or improving the air impermeability of those compositions.

While the addition of naphthenic or paraffinic oils and resins improves some processing properties of rubber compositions, the air impermeability may be adversely influenced. What is lacking in the art is an air barrier that has suitable processing properties and cure properties such as green strength, modulus, tensile strength, and hardness, while maintaining adequate air impermeability provided by butyl rubbers. The present invention solves this and other problems.

### SUMMARY OF THE INVENTION

The present invention is a composition suitable for an air barrier, and may include at least one butyl-type rubber, at least one filler, and polybutene processing oil having a number average molecular weight of at least 400 in one embodiment, and a number average molecular weight of less than 10,000 in another embodiment. The filler can be such materials as calcium carbonate, clay, mica, silica and silicates, talc, titanium dioxide, starch, wood flower, carbon black, and mixtures thereof. The viscosity of the polybutene processing oil is greater than 35 cSt at 100° C. in one embodiment, and naphthenic oil (naphthenic, aliphatic, or paraffinic) is substantially absent. The air permeability of the cured composition of the invention ranges from 1×10⁻⁸ to 4.5×10⁻⁸ cm³·cm/cm²·sec·atm at 65° C. in one embodiment, and has improved aging properties suitable for use as an innerliner or innertube.

### DETAILED DESCRIPTION OF THE INVENTION

The term “phr” is parts per hundred rubber, and is a measure common in the art wherein components of a composition are measured relative to a major elastomer component, based upon 100 parts by weight of the elastomer or elastomers.

As used herein, in reference to Periodic Table “Groups”, the new numbering scheme for the Periodic Table Groups are used as in HAWLEY'S CONDENSED CHEMICAL DICTIONARY 852 (13th ed. 1997).

The term “elastomer”, as used herein, refers to any polymer or composition of polymers consistent with the ASTM D1566 definition. The term “elastomer” may be used interchangeably with the term “rubber”, as used herein.

Butyl Rubber

An elastomer useful in the present invention may be any unsaturated elastomer such as a butyl-type rubber or branched butyl-type rubber. Useful elastomers are unsaturated butyl rubbers such as homopolymers and copolymers of olefins or isoolefins and multiolefins, or homopolymers of multiolefins. These and other types of elastomers suitable for the invention are well known and are described in RUBBER TECHNOLOGY 209-581 (Maurice Morton ed., Chapman & Hall 1995), THE VANDERBILT RUBBER HANDBOOK 105-122 (Robert F. Ohm ed., R. T. Vanderbilt Co., Inc. 1990), and Edward Kresge and H. C. Wang in 8 KIRK-OTHMER ENCYCLOPEDIA OF CHEMICAL TECHNOLOGY 934-955 (John Wiley & Sons, Inc. 4th ed. 1993). Non-limiting examples of unsaturated elastomers useful in the method and composition of the present invention are butyl-type rubbers such as poly(isobutylene-co-isoprene), polyisoprene, polybutadiene, polyisobutylene, poly(styrene-co-butadiene), natural rubber, star-branched butyl rubber, and mixtures thereof. Useful elastomers in the present invention can be made by any suitable means known in the art, and the invention is not herein limited by the method of producing the elastomer.

Butyl rubbers are prepared by reacting a mixture of monomers, the mixture having at least (1) a C₄ to C₁₂ isoolefin monomer component such as isobutylene with (2) a multiolefin, monomer component. The isoolefin is in a range from 70 to 99.5 wt % by weight of the total monomer mixture in one embodiment, and 85 to 99.5 wt % in another embodiment. The multiolefin component is present in the monomer mixture from 30 to 0.5 wt % in one embodiment, and from 15 to 0.5 wt % in another embodiment. In yet another embodiment, from 8 to 0.5 wt % of the monomer mixture is multiolefin.

The isoolefin is a C₄ to C₁₂ compound, non-limiting examples of which are compounds such as isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The multiolefin is a C₄ to C₁₄ multiolefin such as isoprene, butadiene, 2,3-dimethyl-1,3-butadiene, myrcene, 6,6-dimethyl-fulvene, hexadiene, cyclopentadiene, and piperylene, and other monomers such as disclosed in EP 0 279 456 and U.S. Pat. No. 5,506,316 and 5,162,425. Other polymerizable monomers such as styrene and dichlorostyrene are also suitable for homopolymerization or copolymerization in butyl rubbers. One embodiment of the butyl rubber polymer of the invention is obtained by reacting 95 to 99.5 wt % of isobutylene with 0.5 to 8 wt % isoprene, or from 0.5 wt % to 5.0 wt % isoprene in yet another embodiment. Butyl rubbers and methods of their production are described in detail in, for example, U.S. Pat. Nos. 2,356,128, 3,968,076, 4,474,924, 4,068,051 and 5,532,312.

A commercial example of a desirable butyl rubber is EXXON™ BUTYL Grades of poly(isobutylene-co-isoprene), having a Mooney viscosity of from 32±2 to 51±5 (ML 1+8 at 125° C.). Another commercial example of a desirable butyl-type rubber is VISTANEXTM polyisobutylene rubber having a molecular weight viscosity average of from 0.9±0.15 to 2.11±0.23×10⁶.

Another embodiment of a butyl rubber useful in the invention is a branched or “star-branched” butyl rubber. These rubbers are described in, for example, EP 0 678 529 B1, U.S. Pat. Nos. 5,182,333 and 5,071,913. In one embodiment, the star-branched butyl rubber (“SBB”) is a composition of a butyl rubber, either halogenated or not, and a polydiene or block copolymer, either halogenated or not. The invention is not limited by the method of forming the SBB. The polydienes/block copolymer, or branching agents (hereinafter “polydienes”), are typically cationically reactive and are present during the polymerization of the butyl or halogenated butyl rubber, or can be blended with the butyl rubber to form the SBB. The branching agent or polydiene can be any suitable branching agent, and the invention is not limited to the type of polydiene used to make the SBB.

In one embodiment, the SBB is typically a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber (EPDM), ethylene-propylene rubber (EPM), styrene-butadiene-styrene and styrene-isoprene-styrene block copolymers. These polydienes are present, based on the monomer wt %, greater than 0.3 wt % in one embodiment, and from 0.3 to 3 wt % in another embodiment, and from 0.4 to 2.7 wt % in yet another embodiment.

A commercial embodiment of the SBB of the present invention is SB Butyl 4266 (ExxonMobil Chemical Company, Houston Tex.), having a Mooney viscosity (ML 1+8 at 125° C., ASTM D 1646) of from 34 to 44. Further, cure characteristics of SB Butyl 4266 are as follows: MH is 69±6 dN·m, ML is 11.5 ±4.5 dN·m (ASTM D2084).

The butyl rubber component is present in the composition of the invention from 50 to 100 phr in one embodiment, from 70 to 100 phr in another embodiment, and from 85 to 100 phr in yet another embodiment.

Filler and Secondary Rubbers

The elastomeric composition may have one or more filler components such as calcium carbonate, clay, mica, silica and silicates, talc, titanium dioxide, starch and other organic fillers such as wood flower, and carbon black. In one embodiment, the filler is carbon black or modified carbon black. The preferred filler is semi-reinforcing grade carbon black present at a level of from 10 to 150 phr of the composition, more preferably from 30 to 120 phr. Useful grades of carbon black as described in RUBBER TECHNOLOGY 59-85 (1995) range from N110 to N990. More desirably, embodiments of the carbon black useful in, for example, tire treads are N229, N351, N339, N220, N234 and N110 provided in ASTM (D3037, D1510, and D3765). Embodiments of the carbon black useful in, for example, sidewalls in tires, are N330, N351, N550, N650, N660, and N762. Embodiments of the carbon black useful in, for example, innerliners or innertubes are N550, N650, N660, N762, N990, and Regal 85 (Cabot Corporation Alpharetta, GA) and the like.

A secondary rubber component may also be present in the composition and air barrier of the invention. An embodiment of the secondary rubber component present is natural rubber. Natural rubbers are described in detail by Subramaniam in RUBBER TECHNOLOGY 179-208 (1995). Desirable embodiments of the natural rubbers of the present invention are selected from Malaysian rubber such as SMR CV, SMR 5, SMR 10, SMR 20, and SMR 50 and mixtures thereof, wherein the natural rubbers have a Mooney viscosity at 100° C. (ML 1+4) of from 30 to 120, more preferably from 40 to 65. The Mooney viscosity test referred to herein is in accordance with ASTM D-1646.

Other secondary rubbers can also be used in the compositions of the invention. The secondary rubber component of the present composition compositions are selected from natural rubbers, polyisoprene rubber, styrene butadiene rubber (SBR), polybutadiene rubber, isoprene butadiene rubber (IBR), styrene isoprene butadiene rubber (SIBR), ethylene-propylene rubber, neoprene, semi-crystalline copolymer and mixtures thereof. The secondary rubber component of the elastomer composition may be present in a range from up to 50 phr in one embodiment, from up to 40 phr in another embodiment, and from up to 30 phr in yet another embodiment.

In one embodiment of the invention, a so called semi-crystalline copolymer (SCC) is present as the secondary rubber. Semi-crystalline copolymers are described in U.S. Ser. No. 09/569,363, filed on May 11, 2000 (assigned to the assignee of the present invention). Generally, the SCC is a copolymer of ethylene or propylene derived units and α-olefin derived units, the α-olefin having from 4 to 16 carbon atoms in one embodiment, and in another embodiment the SCC is a copolymer of ethylene derived units and α-olefin derived units, the α-olefin having from 4 to 10 carbon atoms, wherein the SCC has some degree of crystallinity. In a further embodiment, the SCC is a copolymer of 1-butene derived units and another α-olefin derived unit, the other α-olefin having from 0.5 to 16 carbon atoms, wherein the SCC also has some degree of crystallinity. The SCC can also be a copolymer of ethylene and styrene.

Polybutene processing oil

Polybutene processing oil is present in the composition of the invention. In one embodiment of the invention, the polybutene processing oil is a low molecular weight (less than 15,000 Mn) homopolymer or copolymer of olefin derived units having from 3 to 8 carbon atoms in one embodiment, preferably from 4 to 6 carbon atoms in another embodiment. In yet another embodiment, the polybutene is a homopolymer or copolymer of a C₄ raffinate. An embodiment of such low molecular weight polymers termed “polybutene” polymers is described in, for example, SYNTHETIC LUBRICANTS AND HIGH-PERFORMANCE FUNCTIONAL FLUIDS 357-392 (Leslie R. Rudnick & Ronald L. Shubkin, ed., Marcel Dekker 1999) (hereinafter “polybutene processing oil” or “polybutene”).

In one embodiment of the invention, the polybutene processing oil is a copolymer of at least isobutylene derived units, 1-butene derived units, and 2-butene derived units. In one embodiment, the polybutene is a homopolymer, copolymer, or terpolymer of the three units, wherein the isobutylene derived units are from 40 to 100 wt % of the copolymer, the 1-butene derived units are from 0 to 40 wt % of the copolymer, and the 2-butene derived units are from 0 to 40 wt % of the copolymer. In another embodiment, the polybutene is a copolymer or terpolymer of the three units, wherein the isobutylene derived units are from 40 to 99 wt % of the copolymer, the 1-butene derived units are from 2 to 40 wt % of the copolymer, and the 2-butene derived units are from 0 to 30 wt % of the copolymer. In yet another embodiment, the polybutene is a terpolymer of the three units, wherein the isobutylene derived units are from 40 to 96 wt % of the copolymer, the 1-butene derived units are from 2 to 40 wt % of the copolymer, and the 2-butene derived units are from 2 to 20 wt % of the copolymer. In yet another embodiment, the polybutene is a homopolymer or copolymer of isobutylene and 1-butene, wherein the isobutylene derived units are from 65 to 100 wt % of the homopolymer or copolymer, and the 1-butene derived units are from 0 to 35 wt % of the copolymer.

Polybutene processing oils useful in the invention typically have a number average molecular weight (Mn) of less than 10,000 in one embodiment, less than 8000 in another embodiment, and less than 6000 in yet another embodiment. In one embodiment, the polybutene oil has a number average molecular weight of greater than 400, and greater than 700 in another embodiment, and greater than 900 in yet another embodiment. A preferred embodiment can be a combination of any lower limit with any upper limit herein. For example, in one embodiment of the polybutene of the invention, the polybutene has a number average molecular weight of from 400 to 10,000, and from 700 to 8000 in another embodiment, and from 700 to 6000 in yet another embodiment. Useful viscosities of the polybutene processing oil ranges from 10 to 6000 cSt (centiStokes) at 100° C. in one embodiment, and from 35 to 5000 cSt at 100° C. in another embodiment, and is greater than 35 cSt at 100° C. in yet another embodiment, and greater than 100 cSt at 100° C. in yet another embodiment.

Commercial examples of such a processing oil are the PARAPOL™ Series of processing oils (ExxonMobil Chemical Company, Houston Tex.), such as PARAPOL™ 450, 700, 950, 1300, 2400 and 2500. The commercially available PARAPOL™ Series of polybutene processing oils are synthetic liquid polybutenes, each individual formulation having a certain molecular weight, all formulations of which can be used in the composition of the invention. The molecular weights of the PARAPOLTM oils are from 420 Mn (PARAPOL™ 450) to 2700 Mn (PARAPOL™ 2500) as determined by gel permeation chromatography. The MWD (Mw/Mn) of the PARAPOL™ oils range from 1.8 to 3 in one embodiment, and from 2 to 2.8 in another embodiment.

Below, Table 1 shows some of the properties of the PARAPOL™ oils useful in embodiments of the present invention, wherein the viscosity was determined as per ASTM D445-97, and the molecular weight by gel permeation chromatography.

TABLE 1
Properties of individual PARAPOL ™ Grades

| | | Viscosity @ |
|---|---|---|
| Grade | Mn | 100° C., cSt |
| 450 | 420 | 10.6 |
| 700 | 700 | 78 |
| 950 | 950 | 230 |
| 1300 | 1300 | 630 |
| 2400 | 2350 | 3200 |
| 2500 | 2700 | 4400 |

Other properties of PARAPOLTM processing oils are as follows: the density (g/mL) of PARAPOLTM processing oils varies from about 0.85 (PARAPOL™ 450) to 0.91 (PARAPOL™ 2500). The bromine number (CG/G) for PARAPOL™ oils ranges from 40 for the 450 Mn processing oil, to 8 for the 2700 Mn processing oil.

The elastomeric composition of the invention may include one or more types of polybutene as a mixture, blended either prior to addition to the elastomer, or with the elastomer. The amount and identity (e.g., viscosity, Mn, etc.) of the polybutene processing oil mixture can be varied in this manner. Thus, PARAPOL™ 450 can be used when low viscosity is desired in the composition of the invention, while PARAPOLTM 2500 can be used when a higher viscosity is desired, or compositions thereof to achieve some other viscosity or molecular weight. In this manner, the physical properties of the composition can be controlled. More particularly, the phrases “a polybutene processing oil”, or “polybutene processing oil” include a single oil or a composition of two or more oils used to obtain any viscosity or molecular weight (or other property) desired, as specified in the ranges disclosed herein.

The polybutene processing oil or oils are present in the elastomeric composition of the invention from 1 to 60 phr in one embodiment, and from 2-40 phr in another embodiment, from 4-35 phr in another embodiment, and from 5-30 phr in yet another embodiment. Preferably, the polybutene processing oil does not contain aromatic groups or unsaturation.

Curing Agents and Accelerators

The compositions produced in accordance with the present invention typically contain other components and additives customarily used in rubber mixes, such as pigments, accelerators, cross-linking and curing materials, antioxidants, antiozonants, and fillers. In one embodiment, processing aids (resins) such as naphthenic, aromatic or paraffinic extender oils may be present from 1 to 30 phr. In another embodiment, naphthenic, aliphatic, paraffinic and other aromatic resins and oils are substantially absent from the composition. By “substantially absent”, it is meant that naphthenic, aliphatic, paraffinic and other aromatic resins are present, if at all, to an extent no greater than 2 phr in the composition.

Generally, polymer compositions, e.g., those used to produce tires, are crosslinked. It is known that the physical properties, performance characteristics, and durability of vulcanized rubber compounds are directly related to the number (crosslink density) and type of crosslinks formed during the vulcanization reaction. (See, e.g., Helt et al., The Post Vulcanization Stabilization for NR, RUBBER WORLD 18-23 (1991). Cross-linking and curing agents include sulfur, zinc oxide, and fatty acids. Peroxide cure systems may also be used. Generally, polymer compositions may be crosslinked by adding curative molecules, for example sulfur, metal oxides (i.e., zinc oxide), organometallic compounds, radical initiators, etc. followed by heating. In particular, the following are common curatives that will function in the present invention: ZnO, CaO, MgO, Al₂O₃, CrO₃, FeO, Fe₂O₃, and NiO. These metal oxides can be used in conjunction with the corresponding metal stearate complex (e.g., Zn(Stearate)₂, Ca(Stearate)₂, Mg(Stearate)₂, and AI(Stearate)₃), or with stearic acid, and either a sulfur compound or an alkylperoxide compound. (See also, Formulation Design and Curing Characteristics of NBR Mixes for Seals, RUBBER WORLD 25-30 (1993). This method may be accelerated and is often used for the vulcanization of elastomer compositions.

Accelerators include amines, guanidines, thioureas, thiazoles, thiurams, sulfenamides, sulfenimides, thiocarbamates, xanthates, and the like. Acceleration of the cure process may be accomplished by adding to the composition an amount of the accelerant. The mechanism for accelerated vulcanization of natural rubber involves complex interactions between the curative, accelerator, activators and polymers. Ideally, all of the available curative is consumed in the formation of effective crosslinks which join together two polymer chains and enhance the overall strength of the polymer matrix. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), 2,2′-benzothiazyl disulfide (MBTS), hexamethylene-1,6-bisthiosulfate disodium salt dihydrate, 2-(morpholinothio) benzothiazole (MBS or MOR), compositions of 90% MOR and 10% MBTS (MOR 90), N-tertiarybutyl-2-benzothiazole sulfenamide (TBBS), and N-oxydiethylene thiocarbamyl-N-oxydiethylene sulfonamide (OTOS), zinc 2-ethyl hexanoate (ZEH), N,N′-diethyl thiourea.

In one embodiment of the invention, at least one curing agent is present from 0.2 to 15 phr, and from 0.5 to 10 phr in another embodiment. Curing agents include those components described above that facilitate or influence the cure of elastomers, such as metals, accelerators, sulfur, peroxides, and other agents common in the art, and as described above.

Processing

The elastomeric compositions of the invention are useful in a number of articles such as air barriers, and in particular such articles as innertubes, innerliners, curing bags, bladders and envelopes. The materials used to make the compositions of the invention are mixed by conventional means known to those skilled in the art, in a single step or in stages. In one embodiment, the carbon black is added in a different stage from zinc oxide and other cure activators and accelerators. In another embodiment, antioxidants, antiozonants and processing materials are added in a stage after the carbon black has been processed with the elastomeric composition, and zinc oxide is added at a final stage to maximize compound modulus. Thus, a two to three (or more) stage processing sequence is preferred. Additional stages may involve incremental additions of filler and processing oils.

The compositions may be vulcanized by subjecting them using heat or radiation according to any conventional vulcanization process. The amount of heat or radiation (“heat”) is that required to affect a cure in the composition, and the invention is not herein limited to the method and amount of heat required to cure the composition in forming a stock material or article. Typically, the vulcanization is conducted at a temperature ranging from about 100° C. to about 250° C. in one embodiment, from 150° C. to 200° C. in another embodiment, for about 1 to 150 minutes.

Suitable elastomeric compositions for such articles as tire innerliners or innertubes may be prepared by using conventional mixing techniques including, e.g., kneading, roller milling, extruder mixing, internal mixing (such as with a Banbury™ mixer) etc. The sequence of mixing and temperatures employed are well known to the skilled rubber compounder, the objective being the dispersion of fillers, activators and curatives in the polymer matrix without excessive heat buildup. A useful mixing procedure utilizes a Banbury™ mixer in which the polymer rubber, carbon black and plasticizer are added and the composition mixed for the desired time or to a particular temperature to achieve adequate dispersion of the ingredients. Alternatively, the rubber and a portion of the carbon black (e.g., one-third to two thirds) is mixed for a short time (e.g., about 1 to 3 minutes) followed by the remainder of the carbon black and oil. Mixing is continued for about 1 to 10 minutes at high rotor speed during which time the mixed components reach a temperature of about 140° C. Following cooling, the components are mixed in a second step on a rubber mill or in a Banbury™ mixer during which the curing agent and optional accelerators, are thoroughly and uniformly dispersed at relatively low temperature, e.g., about 80° C. to about 105° C., to avoid premature curing of the composition. Variations in mixing will be readily apparent to those skilled in the art and the present invention is not limited to any specific mixing procedure. The mixing is performed to disperse all components of the composition thoroughly and uniformly.

An innerliner stock is then prepared by calendering or extruding the compounded rubber composition into a sheet having a thickness of roughly 40 to 100 mil gauge and cutting the sheet material into strips of appropriate width and length for innerliner applications in the tire building operation. The liner can then be cured while in contact with the tire carcass and/or sidewall in which it is placed.

An innertube stock is prepared by extruding the compounded rubber composition into a tubular shape having a thickness of from 50 to 150 mil gauge and cutting the extruded material into a length of appropriate size. The tubes of extruded material are then second cut and the ends spliced together to form the green tube. The tube is then cured to form the finished innertube either by heating to 25° C. to 250° C., or exposure to radiation, or by other techniques known to those skilled in the art.

Embodiments of the air barriers of the present invention include compositions of the polybutene processing oil with butyl rubbers such as poly(isobutylene-co-isoprene) or star-branched butyl rubber. Other components such as cure agents and accelerators may also be present, as well as fillers. One embodiment of the invention is an air barrier such as an innertube consisting essentially of at least one butyl rubber, at least one filler, polybutene processing oil present from 2 to 40 phr, and at least one cure agent such as sulfur, stearic acid, TMTD, and other agents that effect the cure. An example of a composition of the invention suitable for an air barrier such as an innertube is a composition of 100 phr of poly(isobutylene-co-isoprene) (“butyl” in the Tables of data below), 20 to 30 phr of polybutene processing oil, and various cure agents present from 1 to 5 phr each such as zinc oxide, sulfur, TMTD, and stearic acid. Another example of a composition suitable for an air barrier includes 100 phr of star-branched butyl rubber, 20 to 30 phr of polybutene processing oil, at least one filler, and the cure agents.

In one embodiment, an air barrier is formed by combining at least one butyl rubber, a filler, polybutene processing oil having a number average molecular weight of at least 400, and a cure agent; and curing the combined components as described above.

The air barrier composition of the present invention may be used in producing innerliners for motor vehicle tires such as truck tires, bus tires, passenger automobile tires, motorcycle tires, off the road tires, and the like. The air permeability of the cured compositions of the invention range from 1×10⁻⁸ to 4.5×10⁻⁸ cm³·cM/cm²·sec·atm at 65° C. in one embodiment, and from 1.25×10⁻⁸ to 4×10⁻⁸ cm³·cM/cm²·sec·atm at 65° C. in another embodiment, and from 1.5×10⁻⁸ to 3×10⁻⁸·cm³·cm/cm²·sec·atm at 65° C. in yet another embodiment.

Test Methods

Cure properties were measured using a ODR 2000 at the indicated temperature and 3 degree arc. Test specimens were cured at the indicated temperature, typically from 150° C. to 160° C., for a time corresponding to Tc90+appropriate mold lag. When possible, standard ASTM tests were used to determine the cured compound physical properties. Stress/strain properties (tensile strength, elongation at break, modulus values, energy to break) were measured at room temperature using an Instron 4202. Shore A hardness was measured at room temperature by using a Zwick Duromatic. The error (2σ) in measuring 100% Modulus is +0.11 MPa units; the error (2σ) in measuring elongation is +13% units.

The values “MH” and “ML” used here and throughout the description refer to “maximum torque” and “minimum torque”, respectively. The “MS” value is the Mooney scorch value, the “ML(1+4)” value is the Mooney viscosity value. The error (2σ) in the later measurement is ±0.65 Mooney viscosity units. The values of “Tc” are cure times in minutes, and “Ts” is scorch time”.

Molecular weight of the PARAPOL™ polybutene processing oil was determined by gel permeation chromatography, and the values of number average molecular weight (Mn) obtained have an error of +20%. The techniques for determining the molecular weight (Mn and Mw) and molecular weight distribution (MWD) are generally described in U.S. Pat. No. 4,540,753 to Cozewith et al. and references cited therein, and in Verstrate et al., 21 MACROMOLECULES 3360 (1988). In a typical measurement, a 3-column set is operated at 30° C. The elution solvent used may be stabilized tetrahydrofuran (THF), or 1,2,4-trichlorobenzene (TCB). The columns are calibrated using polystyrene standards of precisely known molecular weights. A correlation of polystyrene retention volume obtained from the standards, to the retention volume of the polymer tested yields the polymer molecular weight. The viscosity of the PARAPOLTM polybutene processing oil was determined as per ASTM D445-97.

Tensile measurements were done at ambient temperature on Instron Series IX Automated Materials Testing System 6.03.08. Micro tensile specimens (dog-bone shaped) width of 0.08 inches (0.20 cm) and a length of 0.2 inches (0.5 cm) length (between two tabs) were used. The thickness of the specimens varied and was measured manually by Mitutoyo Digimatic Indicator connected to the system computer. The specimens were pulled at a crosshead speed of 20 inches/min. (51 cm/min.) and the stress/strain data was recorded. The average stress/strain value of at least three specimens is reported. The error (2σ) in tensile measurements is +0.47 MPa units.

Oxygen permeability was measured using a MOCON OxTran Model 2/61 operating under the principle of dynamic measurement of oxygen transport through a thin film as published by R. A. Pasternak et al. in 8 JOURNAL OF POLYMER SCIENCE: PART A-2 467 (1970). The units of measure are cc-mil/m²-day-mmHg. Generally, the method is as follows: flat film or rubber samples are clamped into diffusion cells which are purged of residual oxygen using an oxygen free carrier gas. The carrier gas is routed to a sensor until a stable zero value is established. Pure oxygen or air is then introduced into the outside of the chamber of the diffusion cells. The oxygen diffusing through the film to the inside chamber is conveyed to a sensor which measures the oxygen diffusion rate.

Air permeability was tested by the following method. Thin, vulcanized test specimens from the sample compositions were mounted in diffusion cells and conditioned in an oil bath at 65° C. The time required for air to permeate through a given specimen is recorded to determine its air permeability. Test specimens were circular plates with 12.7-cm diameter and 0.38-mm thickness. The error (2σ) in measuring air permeability is ±0.245 (x10⁸) units. Other test methods are described in Table 2.

### EXAMPLES

The present invention, while not meant to be limiting by, may be better understood by reference to the following example compositions and Tables. The components used and their commercial sources are outlined in Table 3, the actual compositions in the Examples are in Table 4 in parts per hundred rubber (phr), and the experimentally determined properties of those compositions are summarizer in Tables 5 and 6.

The example compositions were mixed by techniques common in the art, the components and their relative amounts listed in Table 4. Particularly, the first pass of components were mixed at 80 rpm in a BANBURYTM size BR mixer at 40 psi RAM pressure with the temperature control unit set at about 66° C. The elastomer was added at time zero. Carbon black and resins were added at 30 seconds of mixing, and oil and remaining ingredients added when the rubber mix reached a temperature of about 110° C. After an additional 1 minute of mixing, the mixer was scraped down, and dumped at about 135° C. Samples were finalized on a mill by addition of the curatives to the masterbatch from the first step of mixing.

The data in Tables 5 and 6 show that the use of polybutene processing oil improves the air barrier qualities of butyl rubbers as well as the aged properties, while maintaining the processability as determined in the Mooney viscosity and scorch values. For example, the butyl rubber control sample has an elongation value of 553% (unaged), and the butyl rubber with 1300 Mn PARAPOLTM has a elongation value of 678% (unaged), as shown in Table 5. The corresponding aged values in Table 6 show respectively a 71% and 94% retention of the elongation upon aging as determined by dividing the aged elongation values by the corresponding unaged values. The elongation values for the butyl-polybutene processing oil compositions in general show a 90-95% retention upon aging. Further, the rubber modulus values of the aged samples show improvement upon aging, which is an indication of the softness of the rubber. For example, the composition of butyl rubber with 950 Mn PARAPOLTM has a 300% Modulus (unaged) of 4.60 MPa, and 3.94 MPa upon aging.

The air retention values for the compositions show an improvement when the polybutene processing oil is present in the composition. For example, the air permeability and MOCON values for butyl rubber control are 3.94×10⁻⁸ cm³-cm/cm²-sec-atm and 40.11 as shown in Table 6, while those of the butyl rubber composition with PARAPOLTM 2400 are 1.96×10⁻⁸ cm³-cm/cm²-sec-atm and 20.76, respectively. Thus, there is an improvement in the air barrier qualities of the butyl rubbers using polybutene in the composition. The data for the SBB rubbers in the CALSOL™/PARAPOL™ composition indicate a similar trend as the butyl composition with CALSOL™/PARAPOL™, thus indicating that compositions of SBB and polybutene shown an improvement in aging and air barrier qualities.

Polybutene processing oil may be used in place of other processing aids in an inner tube formulation of the present invention. Processing aids, such as a naphthenic oil, are required in the tube formulation in order to allow for efficient and non-dusting handling of the uncured (green) elastomer compound in the rubber product manufacturing plant. For example, the Mooney viscosity of the compound has a limited range of values that allows for efficient calendering, extruding and mold-flow characteristics. Too low a Mooney viscosity value causes sagging and loss of shape in the compound, while too high of a value causes poor extrusion and mold flow and a potentially poorly shaped product. However, upon curing the use of these naphthenic processing aids increases the rate of air flow through the walls of the innertube by creating microchannels, thus reducing the air retention of the product. The use of the polybutene processing oil of the present invention in compositions of elastomers either maintains or improves the processing and cure characteristics of the elastomer. Further, use of polybutene processing oil reduced air permeability by up to 50%, depending upon the molecular weight of the oil and identity of the elastomer.

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the true scope of the present invention.

All priority documents are herein fully incorporated by reference for all jurisdictions in which such incorporation is permitted. Further, all documents cited herein, including testing procedures, are herein fully incorporated by reference for all jurisdictions in which such incorporation is permitted.

TABLE 2
Test Methods

| Parameter | Units | Test |
|---|---|---|
| Mooney Viscosity (polymer) | ML 1 + 8, | ASTM D 1646 |
| | 125° C., MU | (modified) |
| Air permeability | cm³-cm/cm²-sec-atm | See text |
| Brittleness | ° C. | ASTM D 746 |
| Green Strength (100% Modulus) | PSI | ASTM D 412 |
| Mooney Viscosity (compound) | ML 1 + 4, | ASTM D 1646 |
| | 100° C.,MU | |
| Mooney Scorch Time | T_{S}5, 125° C., minutes | ASTM D 1646 |
| Oscillating Disk | | |
| Rheometer (ODR) | | |
| @ 160° C., ±3° arc | | |
| ML | deciNewton.meter | ASTM D 2084 |
| MH | dNewton.m | |
| T_{S}2 | minute | |
| T_{c}90 | minute | |
| Cure rate | dN.m/minute | |
| Physical Properties | | |
| press cured Tc | | |
| 90 + 2 min @ 160° C. | | |
| Hardness | Shore A | ASTM D 2240 |
| Modulus 100% | MPa | ASTM D 412 |
| | | die C |
| Tensile Strength | MPa | |
| Elongation at Break | % | |
| Hot Air Aging, | | |
| 72 hrs. @ 125° C. | | |
| Hardness Change | % | ASTM D 573 |
| Tensile Change | % | |
| Elongation Change | % | |
| Weight Change | % | |
| Tear Strength | N/mm | ASTM D 624 |
| Die B & Die C | | |

TABLE 3
Components and Commercial Sources

| Component | Brief Description | Commercial Source |
|---|---|---|
| BUTYL 268 | Poly(isobutylene-co- | ExxonMobil Chemical |
| | isoprene) | Company (Houston, TX) |
| CALSOL ™ 810 | Naphthenic Oil | R.E. Carroll, Inc |
| | ASTM Type 103 | (Trenton, NJ) |
| CAPTAX ™ | 2-mercaptobenzothiazole | R.T. Vanderbilt |
| KADOX ™ 930 | High Purity French | Zinc Corp. of America |
| | Process Zinc Oxide | (Monaca, Pa) |
| PARAPOL ™ | C₄ raffinate | ExxonMobil Chemical |
| | | Company (Houston, TX) |
| SBB | Star-branched butyl | ExxonMobil Chemical |
| | rubber 4266 | Company (Houston, TX) |
| Stearic acid | Cure agent | e.g., C.K. Witco Corp. |
| | | (Taft, LA) |
| Sulfur | cure agent | e.g., R.E. Carroll |
| | | (Trenton, NJ) |
| TMTD | tetramethylthiuram | e.g., R.T. Vanderbilt |
| | disulfide | (Norwalk, CT) |

TABLE 4
Example Compositions

| | | | BUTYL | BUTYL | SBB | SBB |
|---|---|---|---|---|---|---|
| | | | CALSOL | CALSOL | CALSOL | CALSOL |
| | CONTROL | CONTROL | /PARAPOL | /PARAPOL | /PARAPOL | /PARAPOL |
| Components (phr) | BUTYL | SBB | 1300 50/50 | 2400 50/50 | 1300 50/50 | 2400 50/50 |
| BUTYL 268 | 100 | — | 100 | 100 | — | — |
| N660 | 70.00 | 70.00 | 70.00 | 70.00 | 70.00 | 70.00 |
| CALSOL ™ 810 | 25.00 | 25.00 | 12.50 | 12.50 | 12.50 | 12.50 |
| STEARIC ACID | 1.00 | 1.00 | 1.00 | 1.00 | 1.00 | 1.00 |
| KADOX ™ 911 | 5.00 | 5.00 | 5.00 | 5.00 | 5.00 | 5.00 |
| SBB 4266 | — | 100.00 | — | — | 100 | 100 |
| PARAPOL ™ 450 | — | — | — | — | — | — |
| PARAPOL ™ 700 | — | — | — | — | — | — |
| PARAPOL ™ 1300 | — | — | 12.50 | — | 12.50 | — |
| PARAPOL ™ 2400 | — | — | — | 12.50 | — | 12.50 |
| PARAPOL ™ 950 | — | — | — | — | — | — |
| Subtotal | 201.00 | 201.00 | 201.00 | 201.00 | 201.00 | 201.00 |
| 2nd PASS | | | | | | |
| 1st PASS | 201.00 | 201.00 | 201.00 | 201.00 | 201.00 | 201.00 |
| SULFUR | 2.00 | 2.00 | 2.00 | 2.00 | 2.00 | 2.00 |
| CAPTAX ™ | 0.50 | 0.50 | 0.50 | 0.50 | 0.50 | 0.50 |
| TMTD | 1.00 | 1.00 | 1.00 | 1.00 | 1.00 | 1.00 |
| TOTAL | 204.50 | 204.50 | 204.50 | 204.50 | 204.50 | 204.50 |

| | BUTYL/ | BUTYL/ | BUTYL/ | BUTYL/ | BUTYL/ |
|---|---|---|---|---|---|
| | PARAPOL | PARAPOL | PARAPOL | PARAPOL | PARAPOL |
| Components (phr) | 450 | 700 | 950 | 1300 | 2400 |
| BUTYL 268 | 100 | 100 | 100 | 100 | 100 |
| N660 | 70.00 | 70.00 | 70.00 | 70.00 | 70.00 |
| CALSOL ™ 810 | — | — | — | — | — |
| STEARIC ACID | 1.00 | 1.00 | 1.00 | 1.00 | 1.00 |
| KADOX ™ 911 | 5.00 | 5.00 | 5.00 | 5.00 | 5.00 |
| SBB 4266 | — | — | — | — | — |
| PARAPOL ™ 450 | 25.00 | — | — | — | — |
| PARAPOL ™ 700 | — | 25.00 | — | — | — |
| PARAPOL ™ 1300 | — | — | — | 25.00 | — |
| PARAPOL ™ 2400 | — | — | — | — | 25.00 |
| PARAPOL ™ 950 | — | — | 25.00 | — | — |
| Subtotal | 201.00 | 201.00 | 201.00 | 201.00 | 201.00 |
| 2nd PASS | | | | | |
| 1st PASS | 201.00 | 201.00 | 201.00 | 201.00 | 201.00 |
| SULFUR | 2.00 | 2.00 | 2.00 | 2.00 | 2.00 |
| CAPTAX ™ | 0.50 | 0.50 | 0.50 | 0.50 | 0.50 |
| TMTD | 1.00 | 1.00 | 1.00 | 1.00 | 1.00 |
| TOTAL | 204.50 | 204.50 | 204.50 | 204.50 | 204.50 |

TABLE 5
Properties of the compositions

| | | | BUTYL | BUTYL | SBB | SBB |
|---|---|---|---|---|---|---|
| | | | CALSOL | CALSOL/ | CALSOL | CALSOL |
| | CONTROL | CONTROL | /PARAPOL | PARAPOL | /PARAPOL | /PARAPOL |
| Components (phr) | BUTYL | SBB | 1300 50/50 | 2400 50/50 | 1300 50/50 | 2400 50/50 |
| Mooney @ 100° C. | 44.90 | 40.30 | 55.40 | 54.30 | 46.90 | 48.40 |
| ML(1 + 4) | | | | | | |

Scorch @ 125° C.

| | | | | | | |
|---|---|---|---|---|---|---|
| Ts3 | 20.30 | 21.98 | 26.08 | 26.27 | 20.03 | 20.60 |
| Ts5 | 23.37 | 23.98 | 30.50 | 30.27 | 22.87 | 22.67 |
| Ts10 | 26.53 | 26.50 | 34.80 | 34.18 | 26.30 | 25.42 |

ODR 30 min, 3° Arc @ 170° C.

| | | | | | | |
|---|---|---|---|---|---|---|
| MH-ML | 54.00 | 45.11 | 48.33 | 51.69 | 39.47 | 48.77 |
| MH | 61.54 | 50.28 | 57.39 | 60.50 | 45.75 | 55.24 |
| ML | 7.54 | 5.17 | 9.06 | 8.81 | 6.28 | 6.47 |
| Ts2 | 2.17 | 2.20 | 2.16 | 2.23 | 2.25 | 2.12 |
| Tc25 | 3.25 | 3.05 | 3.19 | 3.35 | 3.21 | 3.09 |
| Tc50 | 4.17 | 4.27 | 4.15 | 4.43 | 5.05 | 4.58 |
| Tc90 | 13.27 | 13.40 | 11.34 | 14.29 | 13.95 | 13.31 |
| RATE | 18.34 | 15.27 | 15.4 | 15.61 | 9.42 | 13.6 |

Tensile, Cure- 8 MINS@ 170° C.

| | | | | | | |
|---|---|---|---|---|---|---|
| Hardness @ 25° C. | 52.30 | 48.10 | 47.90 | 49.50 | 49.50 | 50.30 |
| 100% MOD, MPa | 1.82 | 1.79 | 1.61 | 1.98 | 1.70 | 1.66 |
| 200% MOD, MPa | 3.72 | 3.73 | 3.39 | 4.26 | 3.54 | 3.59 |
| 300% MOD, MPa | 5.57 | 5.96 | 5.19 | 6.53 | 5.66 | 5.87 |
| Tensile, MPa | 11.70 | 12.28 | 12.72 | 9.20 | 11.27 | 11.82 |
| Elongation % | 553 | 586 | 631 | 437 | 582 | 581 |

| | BUTYL/ | BUTYL/ | BUTYL/ | BUTYL/ | BUTYL/ |
|---|---|---|---|---|---|
| | PARAPOL | PARAPOL | PARAPOL | PARAPOL | PARAPOL |
| Components (phr) | 450 | 700 | 950 | 1300 | 2400 |
| Mooney @ 100° C. | 49.00 | 55.10 | 60.90 | 56.80 | 59.10 |
| ML(1 + 4) | | | | | |

Scorch @ 125° C.

| | | | | | |
|---|---|---|---|---|---|
| Ts3 | 21.73 | 20.73 | 24.27 | 23.55 | 22.85 |
| Ts5 | 24.98 | 23.32 | 28.55 | 26.83 | 25.87 |
| Ts10 | 28.48 | 26.05 | 32.60 | 30.43 | 29.00 |

ODR 30 min, 3° Arc @ 170° C.

| | | | | | |
|---|---|---|---|---|---|
| MH-ML | 23.58 | 31.96 | 40.47 | 39.70 | 47.22 |
| MH | 31.09 | 40.71 | 50.38 | 49.28 | 57.40 |
| ML | 7.51 | 8.75 | 9.91 | 9.58 | 10.18 |
| Ts2 | 2.14 | 2.22 | 2.19 | 2.23 | 2.27 |
| Tc25 | 2.77 | 3.07 | 3.20 | 3.23 | 3.42 |
| Tc50 | 4.18 | 4.55 | 4.61 | 4.66 | 4.78 |
| Tc90 | 9.64 | 11.33 | 12.51 | 12.82 | 14.01 |
| RATE | 6.57 | 8.04 | 10.11 | 10.04 | 12.1 |

Tensile, Cure- 8 MINS@ 170° C.

| | | | | | |
|---|---|---|---|---|---|
| Hardness @ 25° C. | 36.50 | 42.70 | 45.90 | 45.50 | 47.90 |
| 100% MOD, MPa | 0.95 | 1.15 | 1.41 | 1.30 | 1.65 |
| 200% MOD, MPa | 1.88 | 2.26 | 2.94 | 2.65 | 3.47 |
| 300% MOD, MPa | 3.12 | 3.71 | 4.60 | 4.19 | 5.38 |
| Tensile, MPa | 11.19 | 11.85 | 13.13 | 12.32 | 13.77 |
| Elongation % | 754 | 714 | 695 | 678 | 646 |

TABLE 6
Properties of the compositions

| | | | BUTYL | BUTYL | SBB | SBB |
|---|---|---|---|---|---|---|
| | | | CALSOL | CALSOL | CALSOL | CALSOL |
| | CONTROL | CONTROL | /PARAPOL | /PARAPOL | /PARAPOL | /PARAPOL |
| Components (phr) | BUTYL | SBB | 1300 50/50 | 2400 50/50 | 1300 50/50 | 2400 50/50 |

Aged Tensile, 72 HRS@ 125° C.

| | | | | | | |
|---|---|---|---|---|---|---|
| Hardness @ 25° C. | 49.50 | 63.30 | 47.70 | 44.70 | 54.90 | 57.50 |
| 100% MOD, MPa | 3.17 | 3.17 | 1.82 | 2.29 | 2.18 | 2.31 |
| 200% MOD, MPa | 6.40 | 6.06 | 3.67 | 4.81 | 3.95 | 4.36 |
| 300% MOD, MPa | 8.99 | 8.74 | 5.35 | 7.03 | 5.96 | 6.53 |
| Tensile, MPa | 10.54 | 10.16 | 7.92 | 9.59 | 8.32 | 8.71 |
| Elongation % | 392 | 383 | 497 | 467 | 459 | 413 |
| Die B Tear-- N/mm | 62.89 | 54.66 | 63.59 | 63.15 | 59.38 | 60.41 |
| Tear-Aged | 62.65 | 58.89 | 50.22 | 58.92 | 51.24 | 53.66 |
| 72 HRS@ 125° C. | | | | | | |
| GREEN STRENGTH | | | | | | |
| 100% MOD-PSI | 30.45 | 32.05 | 31.03 | 32.19 | 34.08 | 36.98 |
| 100% MOD-Mpa | 0.21 | 0.22 | 0.21 | 0.22 | 0.24 | 0.26 |
| Time to Decay 75% | 2.00 | 1.93 | 2.08 | 1.89 | 2.00 | 2.20 |
| Tension Set | | | | | | |
| 300% @ RT, 10 mins. | 10.20% | 11.70% | 10.00% | 8.40% | 12.00% | 11.07% |

50% STRAIN @ 105° C., 300 Min

| | | | | | | |
|---|---|---|---|---|---|---|
| After 1440 min. relax | 22.67% | 32.07% | 31.13% | 27.83% | 31.37% | 34.03% |
| Air Permeability Q @ | 3.94 | 4.00 | 2.78 | 2.64 | 2.73 | 2.94 |
| 65° C. cm³-cm/cm²-sec-atm | | | | | | |
| (×10⁸) | | | | | | |
| Mocon @ 60° C. | 40.11 | 40.93 | 30.03 | 29.15 | 31.12 | 29.80 |

| | BUTYL/ | BUTYL/ | BUTYL/ | BUTYL/ | BUTYL/ |
|---|---|---|---|---|---|
| | PARAPOL | PARAPOL | PARAPOL | PARAPOL | PARAPOL |
| Components (phr) | 450 | 700 | 950 | 1300 | 2400 |

Aged Tensile, 72 HRS@ 125° C.

| | | | | | |
|---|---|---|---|---|---|
| Hardness @ 25° C. | 43.10 | 38.70 | 44.50 | 42.30 | 40.30 |
| 100% MOD, MPa | 1.26 | 0.99 | 1.36 | 1.16 | 1.50 |
| 200% MOD, MPa | 2.08 | 1.70 | 2.65 | 2.15 | 3.22 |
| 300% MOD, MPa | 3.04 | 2.57 | 3.94 | 3.32 | 4.95 |
| Tensile, MPa | 5.43 | 5.53 | 7.00 | 6.89 | 9.01 |
| Elongation % | 512 | 659 | 578 | 639 | 590 |
| Die B Tear-- N/mm | 57.46 | 60.69 | 67.86 | 66.91 | 66.32 |
| Tear-Aged | 31.78 | 37.87 | 42.00 | 39.57 | 53.98 |
| 72 HRS@ 125° C. | | | | | |
| GREEN STRENGTH | | | | | |
| 100% MOD-PSI | 28.28 | 34.80 | 36.98 | 35.24 | 34.08 |
| 100% MOD-Mpa | 0.20 | 0.24 | 0.26 | 0.24 | 0.24 |
| Time to Decay 75% | 1.51 | 2.48 | 2.81 | 2.87 | 2.52 |
| Tension Set | | | | | |
| 300% @ RT, 10 mins. | 7.70% | 8.87% | 9.80% | 9.87% | 9.27% |

50% STRAIN @ 105° C., 300 Min

| | | | | | |
|---|---|---|---|---|---|
| After 1440 min. relax | 32.17% | 27.47% | 36.87% | 28.30% | 23.67% |
| Air Permeability Q @ | 3.36 | 2.41 | 2.30 | 1.96 | 1.96 |
| 65° C. cm³-cm/cm²-sec-atm | | | | | |
| (×10⁸) | | | | | |
| Mocon @ 60° C. | 37.76 | 27.67 | 25.92 | 23.00 | 20.76 |

We claim:

1. An air barrier formed by combining at least one butyl rubber, a filler, polybutene processing oil having a number average molecular weight of at least 400, and at least one cure agent; and curing the combined components.

2. The air barrier of claim 1, wherein the polybutene processing oil has a number average molecular weight of at least 700.

3. The air barrier of claim 1, wherein the polybutene processing oil has a number average molecular weight of from 700 to 6000.

4. The air barrier of claim 1, wherein the polybutene processing oil has a number average molecular weight of less than 10,000.

5. The air barrier of claim 1, wherein the polybutene processing oil is present in the composition from 2 to 40 phr.

6. The air barrier of claim 1, wherein the filler is selected from calcium carbonate, clay, mica, silica and silicates, talc, titanium dioxide, starch, wood flower, carbon black, and mixtures thereof.

7. The air barrier of claim 1, wherein the filler is carbon black.

8. The air barrier of claim 1, wherein the viscosity of the polybutene processing oil is from 10 to 6000 cSt at 100° C.

9. The air barrier of claim 1, wherein the air permeability is from 1×10⁻⁸ to 4.5×10⁻⁸ cm³·cm/cm²·sec·atm at 65° C.

10. The air barrier of claim 1, wherein naphthenic oil is substantially absent.

11. The air barrier of claim 1, comprising an innertube.

12. An air barrier formed by combining at least one butyl rubber, at least one filler, polybutene processing oil having a viscosity of greater than 35 cSt at 100° C., and at least one cure agent; and curing the combined components.

13. The air barrier of claim 12, wherein the polybutene processing oil has a number average molecular weight of at least 700.

14. The air barrier of claim 12, wherein the polybutene processing oil has a number average molecular weight of from 700 to 6000.

15. The air barrier of claim 12, wherein the polybutene processing oil has a number average molecular weight of less than 10,000.

16. The air barrier of claim 12, wherein the polybutene processing oil is present in the composition from 2 to 40 phr.

17. The air barrier of claim 12, wherein the at least one filler is selected from calcium carbonate, clay, mica, silica and silicates, talc, titanium dioxide, starch, wood flower, carbon black, and mixtures thereof.

18. The air barrier of claim 12, wherein the filler is carbon black.

19. The air barrier of claim 12, wherein polybutene processing oil has a viscosity of from 10 to 6000 cSt at 100° C.

20. The air barrier of claim 12, wherein the air permeability is from 1×10⁻⁸ to 4.5×10⁻⁸ cm³·cm/cm²·sec·atm at 65° C.

21. The air barrier of claim 12, wherein naphthenic oil is substantially absent.

22. The air barrier of claim 12, comprising an innertube.

23. A composition comprising at least one butyl rubber, at least one filler, and polybutene processing oil having a number average molecular weight of at least 400.

24. The composition of claim 23, wherein the polybutene processing oil has a number average molecular weight of at least 700.

25. The composition of claim 23, wherein the polybutene processing oil has a number average molecular weight of from 700 to 6000.

26. The composition of claim 23, wherein the polybutene processing oil has a number average molecular weight of less than 8000.

27. The composition of claim 23, wherein the polybutene processing oil is present in the composition from 2 to 40 phr.

28. The composition of claim 23, wherein the at least one filler is selected from calcium carbonate, clay, mica, silica and silicates, talc, titanium dioxide, starch, wood flower, carbon black, and mixtures thereof.

29. The composition of claim 23, wherein the filler is carbon black.

30. The composition of claim 23, wherein viscosity of the polybutene processing oil is greater than 35 cSt at 100° C.

31. The composition of claim 23, wherein naphthenic oil is substantially absent.

32. The composition of claim 23, also comprising a cure agent.

33. The composition of claim 32, wherein the composition is heated to a temperature to affect a cure.

34. The composition of claim 33, comprising an innertube.

35. The composition of claim 33, comprising an article selected from an innertube, innerliner, curing bag, and envelope.

36. The composition of claim 33, wherein the air permeability is from 1×10⁻⁸ to 4.5×10⁻⁸ cm³·cm/cm²·sec·atm at 65° C.

37. An elastomeric composition comprising at least one elastomer, at least one filler, and polybutene processing oil having a number average molecular weight of from 400 to 10,000.

38. The composition of claim 37, wherein the polybutene has a viscosity of from 10 to 6000 cSt at 100° C.

39. The composition of claim 37, wherein the polybutene is present from 2 to 30 phr.

40. The composition of claim 37, wherein naphthenic oil is substantially absent.

41. The composition of claim 37, wherein the elastomer is a butyl rubber.

42. The composition of claim 37, wherein the elastomer is selected from poly(isobutylene-co-isoprene), polyisoprene, polybutadiene, polyisobutylene, poly(styrene-co-butadiene), natural rubber, star-branched butyl rubber, and mixtures thereof.

43. The composition of claim 37, wherein the polybutene processing oil is a copolymer of isobutylene derived units and 1-butene derived units.
